(19) United States
(12) Patent Application Publication
(10) Pub. No.: US 2006/0198396 A1
(43) Pub. Date: Sep. 7, 2006

(54) Method and system for multiplexing and transmitting signaling message and supplementary data in a mobile communication system

(75) Inventors: Yong Chang, Seongnam-si, Gyeonggi-do (KR); Ji-Hae Yi, Gyeonggi-do (KR)

Correspondence Address: DILWORTH & BARRESE, LLP, 333 EARLE OVINGTON BLVD., UNIONDALE, NY, 11553, US

(73) Assignee: Samsung Electronics Co., Ltd.;

(21) Appl. No.: 10/531,639

(22) PCT Filed: Jul. 10, 2004
(86) PCT No.: PCT/KR04/01705

§ 371 Date: Dec. 1, 2005

(30) Foreign Application Priority Data
Jul. 10, 2003 (KR) 10 2003 0047012

(51) Int. Cl. H04L 12/66; H04J 3/12

(52) U.S. Cl. 370/522; 370/352

(57) ABSTRACT

Disclosed is a method and system for multiplexing and transmitting a signaling message and supplementary data in a mobile communication system including a media gateway using packet-based transmission and a base station controller. Using Dim-and-Burst (DB) and Blank-and-Burst (BB) newly proposed as the media gateway includes a vocoder, the base station controller requests the media gateway to decrease a voice data rate during voice data transmission to the media gateway in order to multiplex a signaling message and supplementary data and transmit the multiplexed data to a mobile station. Then the vocoder in the media gateway decreases the data rate, thereby efficiently transmitting a signaling message and supplementary data together with voice data.

### BACKGROUND OF THE INVENTION

1. Field of the Invention

The present invention relates to a method and a system for transmitting data in a mobile communication system, and more particularly to a method and a system for multiplexing and transmitting a voice signal, a signaling message, and supplementary data in a mobile communication system which provides internet/multimedia services.

2. Description of the Related Art

With the rapid increase of the number of mobile communication subscribers and with the connection of mobile communication services and internet services, mobile communication terminals have been developed to receive various types of data services, such as internet service and multimedia service. Such a mobile communication system, that is, a code division multiple access mobile communication system (hereinafter, referred to as “CDMA 2000 1×”) will be described below with reference to an accompanying drawing.

FIG. 1 is a block diagram illustrating a structure of a conventional CDMA 2000 1× system.

As shown in FIG. 1, the CDMA 2000 1× includes a mobile switching center (MSC) 30 and a packet data service node (PDSN) 40, in which the mobile switching center 30 switches voice and data transmitted/received from/to a mobile station to a relevant destination in cooperation with a base station 20 and in which the packet data service node 40 performs the function of an interface to exterior internet connections. In addition, the CDMA 2000 1× includes an interworking function (IWF) 50 and a packet control function (PCF) 60, in which the interworking function 50 converts circuit data and packet data into each other and transmits the converted data when the interworking function 50 receives a data transmission request from the mobile switching center 30, and in which the packet control function 60 is connected between the packet data service node 40 and the base station 20 to interface voice signals and data.

The base station 20 includes base transceiver stations (BTSs) 22A and 22B and a base station controller (BSC) 21 for controlling the base transceiver stations (BTSs) 22A and 22B.

An A1 interface and user information A2/A5 interfaces used for only circuit data are established between the mobile switching center 30 and the base station controller 21. Also, an A3 interface is defined as an interface which enables simultaneous transmission of a control signal and user data between the base station controller and another base station in selection of a reverse frame and transmission of a forward frame between them during soft handoff of a terminal.

The base station controller 21 includes a trans-coder (or a vocoder) 23. The trans-coder (or vocoder) 23 functions to convert a wireless vocoder frame into a PCM vocoder frame, which is not a wireless vocoder but a representative wire vocoder, so as to transmit the wireless vocoder (e.g., EVRC, SMV, or Q-CELP) frame, which is transmitted from a terminal through a radio section, to a wire concentrating network after the base station controller 21 receives the wireless vocoder frame. Since the conventional transmission line between a base station controller and a mobile switching center is a TDM line, a frame itself generated by a wireless vocoder of a mobile station cannot be transmitted between them. That is, a frame generated in a wireless vocoder having a used band less than 13 kbps is transmitted in a frame generated in the trans-coder of the base station controller, using all band of 64 kbps.

However, since the transmission line between the base station controller and the mobile switching center is formed in a TDM scheme as described above, there are problems of wasting bandwidth on such a TDM transmission line, dropping the efficiency of the transmission line, and increasing the cost for the TDM transmission line.

Moreover, since it is difficult to perform rapid transmission of packet data for internet/multimedia service in the conventional circuit-based system, a packet-based mobile communication system, such as an IP network, is recently developed. In the case in which the base station controller converts a voice signal using the trans-coder, as in the conventional system, in order to provide a fast packet data service, it is caused to waste band. Therefore, it is necessary to develop a new system.

### SUMMARY OF THE INVENTION

Therefore, the present invention has been made in view of the above-mentioned problems, and it is an object of the present invention to provide a next generation mobile communication system having a packet network, which is separated from a circuit network, so as to be suitable to a packet-based IP network.

Another object of the present invention is to provide a frame protocol capable of processing voice data frames when voice information is transmitted/received between a media gateway and a base station controller in an IP-based next-generation mobile communication system.

Still another object of the present invention is to provide a method for multiplexing a signaling message and supplementary data while voice data are transmitted between a base station controller and a media gateway using a packet-based transmission scheme.

According to an aspect of the present invention, there is provided a method for multiplexing and transmitting a signaling message and/or supplementary data with a voice signal to be transmitted to a mobile station in a mobile communication system which includes a media gateway and a base station controller, the media gateway including a trans-coder for converting an analog voice signal and a coded digital voice signal into each other, the base station controller transmitting/receiving a digital voice signal to/from the media gateway, the method comprising the steps of: transmitting information of the voice signal and a transmission rate of a voice signal, which are transmitted from the mobile station, from the base station controller to the media gateway; transmitting information of a voice signal and a transmission rate of the voice signal, which are transmitted from a called party, from the media gateway to the base station controller; and checking whether or not there is a signaling message and/or supplementary data to be transmitted to the mobile station by the base station controller while the base station controller is transmitting/receiving the voice signal, and multiplexing and transmitting the signaling message and/or the supplementary data with the voice signal to the mobile station when there is the signaling message and/or the supplementary data to be transmitted.

According to another aspect of the present invention, there is provided a method for multiplexing and transmitting a signaling message and/or supplementary data with a voice signal to a mobile station by a base station controller in a mobile communication system which includes a media gateway and the base station controller, the media gateway including a trans-coder for converting an analog voice signal and a coded digital voice signal into each other, the base station controller transmitting/receiving a digital voice signal to/from the media gateway, the method comprising the steps of: judging whether or not there is the signaling message and/or the supplementary data besides of the voice signal; requesting that the media gateway reduces a transmission rate of the voice signal during a predetermined period of time when there is the signaling message and/or the supplementary data; and receiving a response to transmission-rate reduction of the voice signal from the media gateway and transmitting the voice signal and the signaling message and/or the supplementary data to the mobile station by multiplexing the signaling message and/or the supplementary data with the voice signal according to a reduced transmission rate.

According to still another aspect of the present invention, there is provided a method for reducing a transmission rate of a voice signal so that a media gateway can multiplex and transmit the voice signal and a signaling message and/or supplementary data to a mobile station in a mobile communication system which includes the media gateway and a base station controller, the media gateway including a trans-coder for converting an analog voice signal and a coded digital voice signal into each other, the base station controller transmitting/receiving a digital voice signal to/from the media gateway, the method comprising the steps of: reducing a transmission rate of the voice data when the base station controller requests transmission-rate reduction of the voice signal; and transmitting a response to the voice signal transmission-rate reduction request to the base station controller within a predetermined period of time.

According to still another aspect of the present invention, there is provided a system for multiplexing and transmitting a signaling message and/or supplementary data with a voice signal to be transmitted to a mobile station in a mobile communication system which includes a media gateway and a base station controller, the media gateway including a trans-coder for converting an analog voice signal and a coded digital voice signal into each other, the base station controller transmitting/receiving a digital voice signal to/from the media gateway, the system comprising: the media gateway for transmitting information of a voice signal and a transmission rate of the voice signal, which are transmitted from a called party, to the base station controller; and the base station controller for transmitting information of a voice signal and a transmission rate of the voice signal, which are transmitted from the mobile station, to the media gateway, checking whether or not there is a signaling message and/or supplementary data to be transmitted to the mobile station while the base station controller is transmitting/receiving the voice signal, and multiplexing and transmitting the signaling message and/or the supplementary data with the voice signal to the mobile station when there is the signaling message and/or the supplementary data to be transmitted.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram illustrating a structure of a conventional CDMA 2000 1× system;

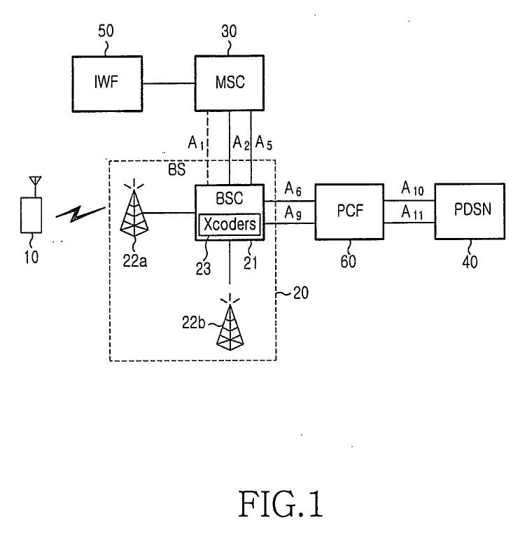

FIG. 2 is a block diagram illustrating a structure of a CDMA 2000 1× system according to an embodiment of the present invention;

FIG. 3 is a format illustrating a protocol stack of a CDMA 2000 1× system according to an embodiment of the present invention;

FIG. 4A is a format illustrating an A2p reverse frame message of a frame protocol according to an embodiment of the present invention;

FIG. 4B is a format illustrating information of ‘reverse layer-3 data’ from among the A2p reverse frame message shown in FIG. 4A;

FIG. 5A is a format illustrating an A2p forward frame message of a frame protocol according to an embodiment of the present invention;

FIG. 5B is a format illustrating information of ‘forward layer-3 data’ from among the A2p forward frame message information shown in FIG. 5A;

FIG. 6 is a format illustrating a message error check message of a frame protocol according to an embodiment of the present invention;

FIGS. 7A and 7B are formats illustrating transmission-rate reduction request and acknowledgment messages when out-of-band signaling of a frame protocol is used according to an embodiment of the present invention, respectively;

FIGS. 8A and 8B are formats illustrating reverse/forward frame messages when out-of-band signaling of a frame protocol is used according to an embodiment of the present invention, respectively;

FIG. 9 is a flowchart illustrating operations for reducing a transmission rate so as to multiplex and transmit a signaling message or supplementary data in a transmission section of a voice data according to an embodiment of the present invention;

FIG. 10 is a flowchart illustrating operations for reducing a transmission rate so as to multiplex and transmit a signaling message or supplementary data in a transmission section of a voice data according to another embodiment of the present invention; and

FIG. 11 is a flowchart illustrating operations when a call procedure for reducing a transmission rate is successfully performed according to an embodiment of the present invention.

### DETAILED DESCRIPTION OF THE PREFERRED EMBODIMENTS

Reference will now be made in detail to the preferred embodiments of the present invention. In the following description of the present invention, a detailed description of known functions and configurations incorporated herein will be omitted when it may make the subject matter of the present invention unclear.

According to a mobile communication system of the present invention, the conventional mobile switching center is divided into a mobile switching center emulator (MSC emulator) and a media gateway (MGW), in which the MSC emulator tales charge of a call control and a mobility control. The media gateway takes charge of converting voice data from an analog signal/digital signal into a digital signal/analog signal and forwarding the converted data. Therefore, a bearer interface for transmitting voice information between a mobile switching center and a base station controller in the prior art corresponds to an interface between the media gateway and a base station controller in the present invention. In addition, a frame protocol capable of checking packet arrival sequence and a transmission state between the media gateway and the base station controller is newly established so as to transmit voice information to be transmitted/received from/to a mobile station. Also, the mobile communication system of the present invention is an LMSD (Legacy MS Domain) system of a CDMA (Code Division Multiple Access) 2000 1', and is shown in a network reference model between a radio access network (RAN) and a core network (CN). Such a next generation mobile communication system (hereinafter, referred to as “CDMA 200 1×”) will be described in detail with reference to the accompanying drawings.

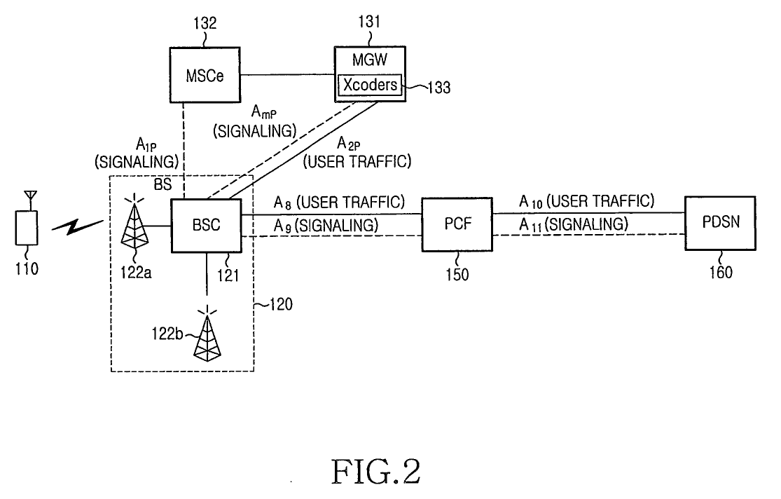

FIG. 2 is a block diagram illustrating a structure of a CDMA 2000 1× system according to an embodiment of the present invention.

As shown in FIG. 2, the CDMA 2000 1× system includes a base station controller 121, a media gateway 131, a mobile switching center emulator (MSC emulator) 132, a packet data service node (PDSN) 160, and a packet control function (PCF) 150.

The media gateway 131 cooperates with the base station controller 121, and includes a trans-coder 133 for converting an analog voice signal and a digital signal into each other. The trans-coder 133 performs a forward operation which converts a voice data frame, which is transmitted from a normal wire telephone, into a wireless vocoder frame used in a wireless terminal, using a pulse code modulation (PCM) scheme. Also, the trans-coder 133 performs a reverse operation which converts voice data generated by the wireless vocoder of the wireless terminal into PCM voice data of 64 kbps, using a pulse code modulation (PCM) scheme. That is, the trans-coder 133 performs a coding operation at a reduced transmission rate when there is no voice signal, and the trans-coder 133 performs a coding operation at a maximum transfer rate when there are a large number of voice signals.

The MSC emulator 132 exchanges a call control signal, a mobility control signal, and a signal for controlling the media gateway 131. The packet control function 150 cooperates with the packet data service node 160 which is connected to an exterior internet. The packet control function 150 controls and manages handoffs, and manages packet data service profiles of mobile stations.

The MSC emulator 132 and the base station controller 121 are connected with each other through an A1p interface, which corresponds to the conventional A1 interface. The base station controller 121 and the media gateway 131 are connected with each other through an A2p interface which corresponds to the conventional A2 interface. Also, an Amp interface is established between the base station controller 121 and the media gateway 131 to perform out-of-band signaling for the purpose of establishing, maintaining, and managing a bearer. The functions defined for the Amp interface may be performed by in-band signaling in the frame protocol of the A2p interface. Such the A1p, A2p, and Amp interfaces are not normal circuit-based interfaces but packet-based (ATM or IP) interfaces.

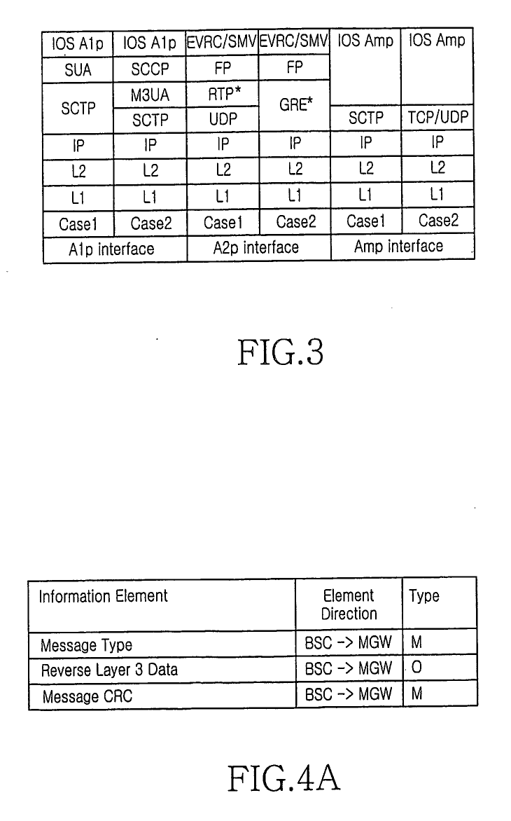

An example of a protocol stack which is defined in an interface between the base station controller and the media gateway will be described below with reference to FIG. 3.

In the protocol stack, “Case 1” applied to the present invention will be described, but the description of “Case 2” will be omitted.

In the protocol stack of the A2p interface, RTP* (Real time Transport Protocol*) and GRE* (Generic Route Encapsulation*) have functions somewhat modified from those of the conventional RTP and GRE, respectively. This means that it is unnecessary that the RTP* and GRE* require all functions, which includes a function of multiplexing data of multiple users with a single port, of the conventional RTP and GRE.

The Amp interface is an interface for out-of-band signaling in a control process provided by the frame protocol, and is established as a separate interface. When, the Amp interface is matched with the media gateway via the MSC emulator, an SCTP (Session Control Transmission Protocol) of the protocol stack is used.

The frame protocol defined in the above-mentioned protocol stack will be described below. When voice information is transmitted/received between the media gateway and the base station controller, the frame protocol operating on the RTP or the GRE provides a procedure for processing a voice data frame and a control procedure thereof. The principal functions of the frame protocol are as follows.

First, the frame protocol has a function of forming and transmitting a frame before voice data information is transmitted, and a function of dividing a frame into control information and voice data information to analyze the divided information after the relevant frame is received.

Second, the frame protocol has an initialization function which includes a function of appointing quality of service (QoS) of a transmission line before voice data are transmitted between the base station controller and the media gateway and a function of appointing the number of a transmitted/received frame when the frame is transmitted/received.

Third, the frame protocol has a function of establishing and maintaining synchronization during actual transmission/reception through a report of delay so as to solve a delay problem caused when voice data information is transmitted/received in real time.

Fourth, the frame protocol has a vocoder transmission control function of changing the transmission rate and the transmission mode of a vocoder included in the media gateway so as to be matched with a vocoder of a mobile station when the transmission rate and the transmission mode of the vocoder included in the mobile station are changed.

Fifth, the frame protocol has a function of controlling a transmission rate of voice data transmitted from the media gateway at a specific time so as to multiplex a signaling message and supplementary data (secondary traffic), which are generated in a DB (Dim and Burst) scheme or a BB (Blank and Burst) scheme in the base station controller, and a voice data frame, and to transmit the multiplexed data to a mobile station.

In the present invention, the fifth function from among the above-mentioned functions of the frame protocol, that is, a method for controlling a transmission rate of voice data so as to perform multiplexing, will be described.

First, an example of the frame protocol for the control (i.e., reduction) of a transmission rate according to the present invention will be described with the accompany drawings.

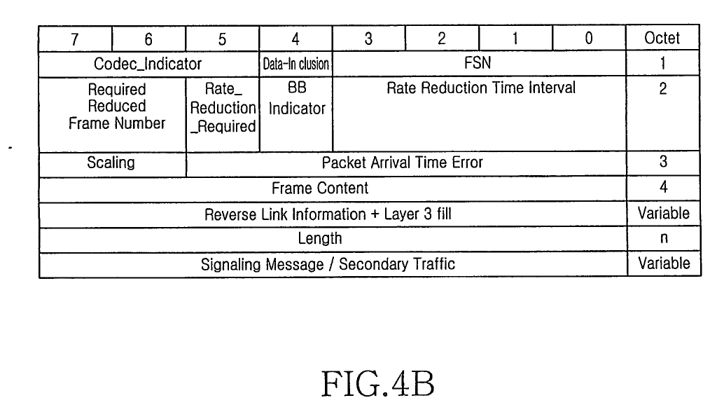

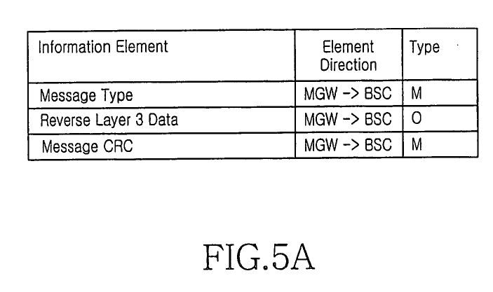

FIG. 4A is a format illustrating an A2p reverse frame message of a frame protocol for reducing a transmission rate according to an embodiment of the present invention and FIG. 4B is a format illustrating information of ‘reverse layer-3 data’ from among the A2p reverse frame message information shown in FIG. 4A.

Referring to FIG. 4A, the A2p reverse frame message (A2p Frame_Reverse) is a message to be transmitted from the base station controller to the media gateway and necessarily includes information related to message type and message error check (Message CRC). In addition, the A2p reverse frame message selectively includes reverse layer-3 data information elements. The reverse layer-3 data information elements are elements of information transmitted to reduce a transmission rate for the purpose of performing multiplexing on the A2p interface when in-band signaling is performed. Such reverse layer-3 data information elements will now be described with reference to FIG. 4B.

“Codec Indicator” represents information related to a codec which is currently in use. As shown in Table 1 below, a codec indicator value of “000” represents a codec of an EVRC (Enhanced Variable Rate Coding) scheme, a codec indicator value of “001” represents a codec of an SMV (Selectable Mode Vocoder) scheme, codes indicator values of “010” and “011” represents codecs of 13K and 8K Q-CELP (Qualcom Code Excited Linear Prediction) coding schemes, respectively, and a codec indicator value of “100” represents a codec of AMR (Adaptive Multi-Rate) coding scheme. Codec indicator values of “101” to “111” are reserved values.

TABLE 1

| Codec Indicator value | Meaning |
|---|---|
| 000 | EVRC |
| 001 | SMV |
| 010 | 13K Q-CELP |
| 011 | 8K Q-CELP |
| 100 | AMR |
| 101˜111 | Reserved |

Frame Sequence Number (FSN)” represents information appointed by a value obtained by performing a modulo-operation with sixteen for a value representing system time according to frames by the base station controller. The value obtained through the modulo-operation may represent a point of time at which the base station controller receives a frame backwardly from the base transceiver station.

“Required Reduced Frame Number” represents information related to the number of 20 ms frames required to be reduced for reducing a transmission rate when a signaling message to be transmitted from the base station controller must be multiplexed through multiple 20 ms frames to be transmitted. That is, it may be required to reduce as many forward frames as the value of the “Required Reduced Frame Number”, which is shown in Table 2.

TABLE 2

| Required Reduced Frame Number Value | Meaning |
|---|---|
| 00 | One 20 ms frame |
| 01 | Two 20 ms frames |
| 10 | Three 20 ms frames |
| 11 | Four 20 ms frames |

“Rate Reduction Required” is a field of indicating that the base station controller is in a rate reduction time interval. If there is a signaling message to be transmitted, the value of “Rate Reduction Required” is set as “1”, and if not, the value is set as “0”.

“BB Indicator” is a Blank and Bust indicator. If the base station controller requires a BB scheme so as to transmit a signaling message or supplementary data, the value of “BB indicator” is set as “1”, and if not, the value is set as “0” which indicates the Dim and Burst scheme.

“Data Inclusion” is a field of indicating whether or not a signaling message or secondary traffic to be multiplexed and transmitted by the base station controller will be inserted into the current frame protocol reverse data to be transmitted. If a signaling message or supplementary data are inserted, the value of “Data Inclusion” is set as “1”, and if not, the value is set as “0”. When the value of “Data Inclusion” is set as “1”, a signaling message or supplementary data corresponding to a value set in a “Length” field are inserted.

“Rate Reduction Time Interval” is a field of indicating a time interval during which the base station controller desires to transmit a signaling message or secondary traffic. The values of the “Rate Reduction Time Interval” are in a range of values which are set at intervals of 20 ms from a point of time set in the “FSN (Frame Sequence Number)” field. That is, the respective values of “Rate Reduction Time Interval” represent one of a range of “a value (decimal) of Rate Reduction Time Interval×20 ms”, and a range has a time interval of 320 ms from CDMA System Time represented in “FSN”.

“Scaling” represents a time scale set for values of a packet arrival time error (PATE) by the base station controller. The values of “Scaling” are shown in Table 3.

TABLE 3

| Scaling Field Value | Time Units | PATE Range |
|---|---|---|
| 00 | 0.125 ms | ±3.875 ms |
| 01 | 1.0 ms | ±31.0 ms |
| 10 | 1.25 ms | ±38.75 ms |
| 11 | 5.0 ms | ±155 ms |

The packet arrival time error (PATE) represents a difference between a reception time in which the media gateway actually receives FP-Forward Layer-3 Data (Frame Protocol-Forward Layer-3 Data) and an expected arrival time calculated by the “Scaling” field. Therefore, the ranges of the PATE are represented as “±” and are established as shown in Table 3 according to values set in the “Scaling” field.

“Frame Content” is a field of indicating the number of information bits and a code symbol repetition rate which are included in actual FP-forward layer-3 data information. Types of frames used for in-band signaling between the base station controller and the media gateway are shown in Tables 4 and 5 below.

TABLE 4

| Frame | | | |
|---|---|---|---|
| Content | | Description | |
| (hex) | Name | Forward | Reverse |
| 00 | Idle' | Transmitted for frame | Transmitted for frame |
| | | synchronization | synchronization |
| | | between BSC and MGW | between BSC and MGW |
| | | before establishment | before establishment |
| | | of wireless resource | of wireless resource |
| 7C | Blank' | Transmitted when being | Transmitted when used |
| | | used in Blank and | in Blank and Burst |
| | | Burst | |
| 7D | Full Rate | Not Applicable | Radio Configuration |
| | Likely | | 1, Full Rate Likely |
| 7E | Erasure/ | Not Applicable | Insufficient Physical |
| | | | Layer Frame Quality |
| 7F | Null' | Used during DTX mode | Used during DTX mode |
| | | (When transmitting | (When there is only a |
| | | Null traffic frames to | pilot channel and no |
| | | the MS) | frames are being |
| | | | received on the |
| | | | traffic channel) |

TABLE 5

| Frame | | | Number of | Number of |
|---|---|---|---|---|
| Content | Radio | Data Rate | Layer 3 | Information |
| (hex) | Configuration | (bps) | Fill Bits | Bits |
| 01 | Forward: 1 | 9600 | 4 | 172 |
| 02 | and | 4800 | 0 | 80 |
| 03 | Reverse: 1 | 2400 | 0 | 40 |
| 04 | | 1200 | 0 | 16 |
| 05 | Forward: 2 | 14400 | 4 | 268 |
| 06 | and | 7200 | 3 | 125 |
| 07 | Reverse: 2 | 3600 | 1 | 55 |
| 08 | | 1800 | 3 | 21 |
| 09 | Forward: | Unused | — | — |
| 0A | 3, 4, 6, 7 | 9600 | 4 | 172 |
| | and | (20 ms) | | |
| 0B | Reverse: 3, 5 | 4800 | 0 | 80 |
| 0C | | 2700 | 0 | 40 |
| 0D | | 1500 | 0 | 16 |
| 0E | Forward: | Unused | — | — |
| 0F | 5, 8, 9 | 14400 | 5 | 267 |
| 10 | and | 7200 | 3 | 125 |
| 11 | Reverse: 4, 6 | 3600 | 1 | 55 |
| 12 | | 1800 | 3 | 21 |

“Length” contains information about a length of bytes included after the “Length” field.

“Signaling message/Secondary Traffic” represents inserted signal message or supplementary data (secondary traffic) when the value of “Signaling message/Secondary Traffic” is set as “1”.

Also, the forward layer-3 data information may selectively includes forward-link information elements (Forward Link Information+Layer-3 fill) in addition to the above-mentioned information elements.

Meanwhile, during the performance of a frame protocol control procedure, when data are processed using in-band signaling on the A2p interface, the media gateway transmits a transmission-rate reduction acknowledgment message to a base station in response to a transmission-rate reduction request message. Information elements for the transmission-rate reduction acknowledgment message will be described below.

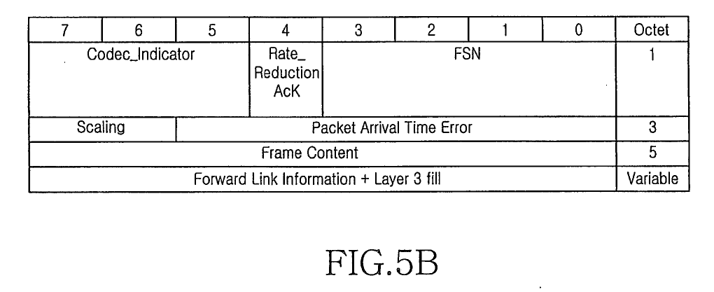

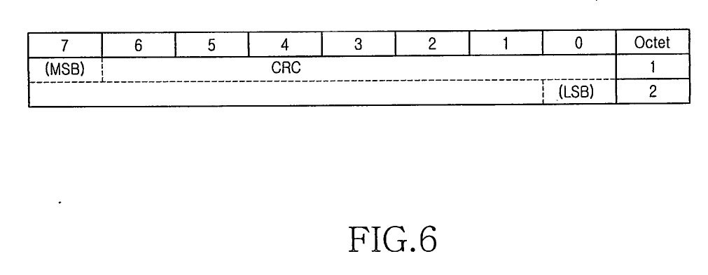

FIG. 5A is a format illustrating an A2p forward frame message of a frame protocol for reducing a transmission rate according to an embodiment of the present invention, and FIG. 5B is a format illustrating information of ‘forward layer-3 data’ from among the A2p forward frame message information shown in FIG. 5A.

In in-band signaling, voice data and control information of a frame protocol are transmitted through the same message. When in-band signaling is used to reduce a transmission rate, a format of a forward frame message of a frame protocol, as shown in FIG. 5A, necessarily includes information related to message type and message error check (Message CRC). In addition, the format of the forward frame message selectively includes forward layer-3 data information elements. Such forward layer-3 data information elements will now be described with reference to FIG. 5B.

“Codec Indicator” is a field of indicating information related to a codec which is currently in use. The codec information is discriminated according to values of the codec indicator in the same manner as in the codec information of reverse layer-3 shown in Table 1.

A transmission-rate reduction acknowledgment (Rate_Reduction_Ack) field is set as “1” when the media gateway acknowledges a transmission-rate reduction request, which is received from the base station controller to use the DB (Dim and Burst) scheme, and reduces the transmission rate according to the transmission-rate reduction request. Either in a case opposite to the above or as a basic value, the transmission-rate reduction acknowledgment field is set as “0”.

Frame Sequence Number (FSN)” is a field appointing a value obtained by performing a modulo-operation with sixteen for a value representing system time according to frames by the media gateway. The value obtained through the modulo-operation may be used as a forward transmission time from the base station controller to the base transceiver station.

“Scaling” is a field in which the media gateway sets a time scale for values of a packet arrival time error (PATE). The values of “Scaling” are the same as those shown in Table 3.

The packet arrival time error (PATE) is a field of indicating a difference between a reception time in which the base station controller actually receives RP-Forward Layer-3 Data (Reverse Protocol-Forward Layer-3 Data) and an expected arrival time calculated by the “Scaling” field. Therefore, the ranges of the PATE are represented as “±”, and are established as shown in Table 3 according to values set in the “Scaling” field.

“Frame Content” is a field of indicating the number of information bits and a code symbol repetition rate. Types of frames used for in-band signaling between the base station controller and the media gateway are same as those shown in Tables 4 and 5.

Also, the forward layer-3 data information may selectively includes forward-link information elements (Forward Link Information+Layer-3 fill) in addition to the above-mentioned information elements.

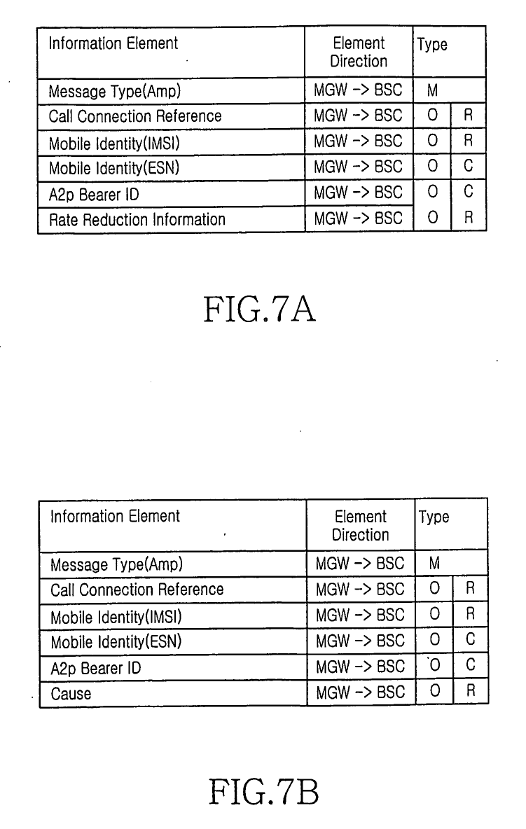

FIG. 6 is a format of representing information of message error check which is included in an A2p reverse/forward frame message of a frame protocol according to an embodiment of the present invention.

The message error check has standard 16-bit information which is applied to forward layer-3 data and a message type, and checks a relevant message and a layer-3 data information element. For such a checking, a generator polynomial “g(x)=X16+X12+X5+1” is used.

The following description will be given of information elements for a transmission-rate reduction request message (i.e., Amp reverse frame message) and a transmission-rate reduction acknowledgment message (i.e., Amp forward frame message), which are individually transmitted through the Amp interface, when out-of-band signaling is used during the performance of a frame protocol control procedure. First, the transmission-rate reduction request message will be described with reference to the accompanying drawing.

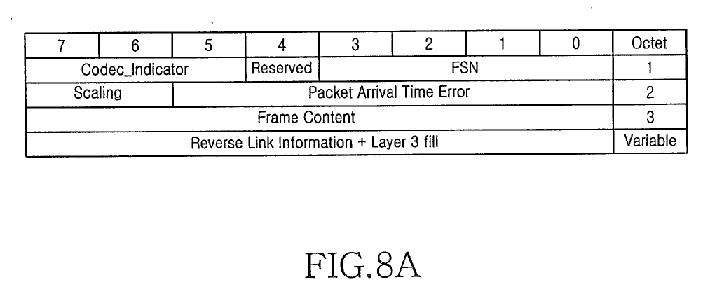

FIG. 7A is a format illustrating an Amp transmission-rate reduction request message of a frame protocol for reducing a transmission rate according to an embodiment of the present invention.

“Message Type” is one-byte information representing a transmission-rate reduction request message transmitted through the Amp interface. “Call Connection Reference” is information representing a voice call connection number of a relevant mobile station on the base station controller and the media gateway, relevant fields of which is shown in Table 6.

TABLE 6

| | | | | | | | | |
|---|---|---|---|---|---|---|---|---|
| 7 | 6 | 5 | 4 | 3 | 2 | 1 | 0 | Octet |

| Amp Element Identifier | | 1 |
|---|---|---|
| Length | | 2 |
| (MSB) | Market ID | 3 |

| | | |
|---|---|---|
| Market ID (continued) | (LSB) | 4 |

| | | |
|---|---|---|
| (MSB) | Generating Entity ID | 5 |

| | | |
|---|---|---|
| Generating Entity ID (continued) | (LSB) | 6 |

| | |
|---|---|
| (MSB) | 7 |

| Call Connection Reference Value | | 8 |
|---|---|---|
| | | 9 |
| | (LSB) | 10 |

Referring to Table 6, information of “Call Connection Reference” includes a “Length” field, a two-byte “Market ID” field which represents a market ID established by a service provider, a two-byte code number (hereinafter, referred to as “Generating Entity ID”) field which represents a code number assigned from a service provider to a device which generates a value of a call connection number, and a four-byte “Call Connection Reference Value” field which represents a value assigned by the “Generating Entity” to be used for discriminating whether or not a relevant mobile station transmits voice data.

“Mobile Identity” (e.g., IMSI or ESN) is information representing a number of a relevant terminal, and includes a “Length” field and a “Type of Identity” field. Fields of the mobile identity are shown in Table 7.

TABLE 7

| | | | | | | | | |
|---|---|---|---|---|---|---|---|---|
| 7 | 6 | 5 | 4 | 3 | 2 | 1 | 0 | Octet |

| A9 Element Identifier | | | 1 |
|---|---|---|---|
| Length | | | 2 |
| Identity Digit 1 | Odd/even | Type of Identity | 3 |
| | Indicator | | |

| Identity Digit 3 | Identity Digit 2 | 4 |
|---|---|---|
| | | . . . |
| Identity Digit N + 1 | Identity Digit N | 5 |

The “Type of Identity” field represents various kinds of identities for mobile stations as shown in Table 8.

TABLE 8

| Binary Values | Meaning |
|---|---|
| 000 | No Identity Code |
| 010 | Broadcast Address |
| 101 | ESN |
| 110 | IMSI |

“A2p bearer ID” represents information related to a bearer ID of the base station controller and the media gateway which is used to transmit voice data between the base station controller and the media gateway, and indicates a port number of an RTP/UDP/IP or a GRE/IP of a transmitting party.

“Rate Reduction Information” is configured as shown in Table 10, each field of which will be described below.

TABLE 9

| | | | | | | | | |
|---|---|---|---|---|---|---|---|---|
| 7 | 6 | 5 | 4 | 3 | 2 | 1 | 0 | Octet |

| | | | | |
|---|---|---|---|---|
| Required | BB | Data_in- | Rate Reduction Time Interval | 1 |
| Reduced Frame | Indicator | clusion | | |
| Number | | | | |

| | | |
|---|---|---|
| Action Time | Reserved | 2 |
| Length | | 3 |

| | |
|---|---|
| Signaling Message/Secondary Traffic | Variable |

“Required Reduced Frame Number” is a field of indicating the number of 20 ms frames required to be reduced for reducing a transmission rate when a signaling message to be transmitted from the base station controller must be multiplexed through multiple 20 ms frames to be transmitted. Values of the “Required Reduced Frame Number” may be defined as shown in Table 2, in which it is required to reduce as many forward frames as the value of the “Required Reduced Frame Number”.

“BB Indicator” is a Blank and Bust indicator. If the base station 10 controller requires a BB scheme so as to transmit a signaling message or supplementary data, the value of “BB indicator” is set as “1”, and if not, the value is set as “0” which means a Dim and Burst scheme.

“Data Inclusion” is a field of indicating whether or not a signaling message or secondary traffic to be multiplexed and transmitted by the base station controller will be inserted into current frame protocol reverse data (FP-Reverse Data) to be transmitted. If a signaling message or supplementary have been inserted, the value of “Data Inclusion” is set as “1”, and if not, the value is set as “0”. When the value of “Data Inclusion” is set as “1”, a signaling message or supplementary data corresponding to a value set in a “Length” field are inserted.

“Rate Reduction Time Interval” is a time interval during which the base station controller desires to transmit a signaling message or secondary traffic. The “Rate Reduction Time Interval” represents a value which is established by the “Rate Reduction Time Interval” field at intervals of 20 ms from a point of time set in an “Action Time” field. That is, the respective values of “Rate Reduction Time Interval” represent one of a range of “a value of Rate Reduction Time Interval×20 ms”.

TABLE 10

| | | | | | | | | |
|---|---|---|---|---|---|---|---|---|
| 7 | 6 | 5 | 4 | 3 | 2 | 1 | 0 | Octet |

| Amp Element Identifier | | 1 |
|---|---|---|
| Length | | 2 |
| 0/1 | Cause Value | 3 |

TABLE 11

| Binary Values | Meaning |
|---|---|
| 000 | Normal Event |
| 001 | Normal Event |
| 010 | Initialization is unavailable |
| 011 | Time Synchronization is unavailable |
| 100 | Rate Control is unavailable |
| 101 | SMV Mode Control is unavailable |
| 110˜111 | Reserved |

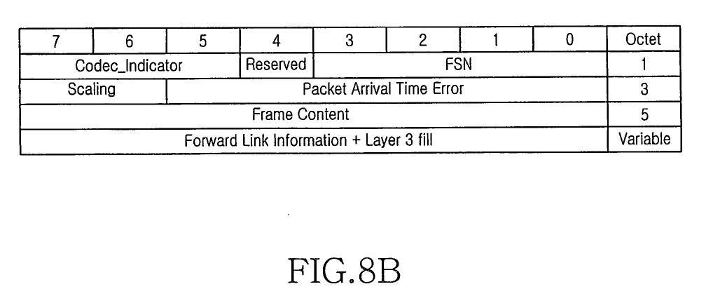

In addition, as shown in FIGS. 8A and 8B, when an out-of-band signaling is used, A2p frame forward/reverse messages includes the same fields as those of the A2p frame forward/reverse messages for the in-band signaling, respectively, except for eliminating fields relating to transmission-rate reduction which are included in the A2p frame forward/reverse messages for the in-band signaling.

A description will be given of methods for reducing a transmission rate to multiplex a signal and supplementary data in a voice data transmission section between a base station controller and a media gateway in the CDMA 2000 1× constructed as above. The methods for reducing a transmission rate will be described with respect to cases of an in-band signaling process and an out-of-band signaling process, respectively.

First, a description will be given with respect to a method for reducing a transmission rate in the case of using the in-band signaling with reference to the accompanying drawing, in which a control message is included in a transmission frame of a frame protocol and is transmitted together with the transmission frame.

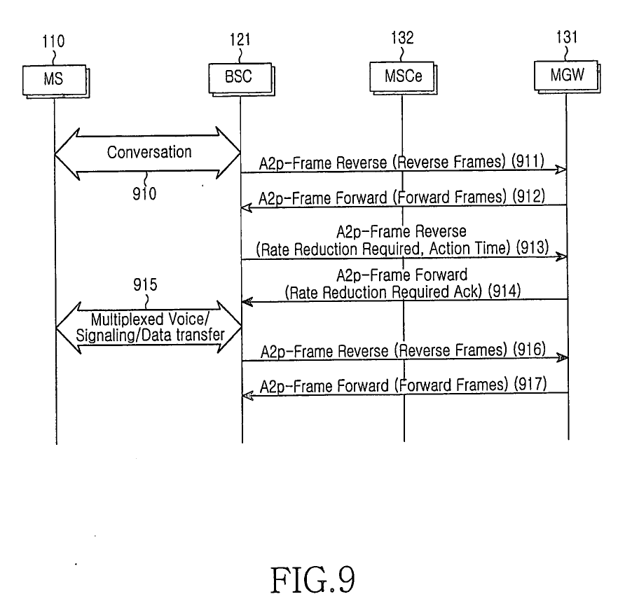

FIG. 9 is a flowchart illustrating a call processing procedure applied to an in-band signaling for the purpose of reducing a transmission rate according to an embodiment of the present invention.

In step 910, after a mobile station 110 establishes a session with a base station controller 121, the mobile station 110 performs voice communication with a called party.

After this, in step 911, the base station controller 121 inserts a voice data frame received from the mobile station 110 into an A2p reverse frame message, and transmits the A2p reverse frame message to a media gateway 131. The transmitted A2p reverse frame message includes information bits and a transmission rate of the received voice data. Then, in step 912, the media gateway 131 inserts information bits and a transmission rate of voice data, which is received through a voice data frame from a media gateway (which is not shown) of the called party, into an A2p forward frame message, and transmits the A2p forward frame message to the base station controller 121.

In step 913, during the performance of a voice call, when a signaling message or supplementary data to be transmitted from the base station controller 121 to the mobile station 110 are generated, the base station controller 121 judges whether or not the base station controller 121 will perform multiplexing with respect to voice data which is currently being transmitted. As a result, when the base station controller 121 determines that the base station controller 121 will perform multiplexing, the base station controller 121 transmits A2p reverse frames to the media gateway 131 after appointing some of the A2p reverse frames to request reduction of a transmission rate according to the DB (Dim and Burst) or the BB (Blank and Burst) scheme at a time point (Action Time) predetermined for multiplexing.

In step 914, when the media gateway 131 acknowledges the transmission-rate reduction request of the base station controller 121, the media gateway 131 reduces the transmission rate according to the DB (Dim and Burst) or the BB (Blank and Burst) scheme at the action time required by the base station controller 121. Then, the media gateway 131 transmits an A2p forward frame to the base station controller 121 after appointing the A2p forward frame to inform that the transmission-rate reduction request has been acknowledged.

In step 915, the base station controller 121 transmits voice data and a signaling message/supplementary data to the mobile station 110 according to the DB (Dim and Burst) or the BB (Blank and Burst) scheme.

In step 916, when there is no signaling message and no supplementary data to be multiplexed and transmitted, the base station controller 121 again normally inserts information bits and a transmission rate of voice data, which are received through a voice data frame from the mobile station 110, into an A2p reverse frame, and transmits the A2p reverse frame as packet data to the media gateway 131.

In step 917, the media gateway 131 inserts information bits and a transmission rate of voice data, which are received through a voice data frame from the media gateway of the called party, into an A2p forward frame, and transmits the A2p forward frame to the base station controller 121.

The above description has shown the method of reducing a transmission rate so as to multiplex a signal and supplementary data in a voice data transmission section by using the in-band signaling in which a voice signal and data are transmitted by a single message. Hereinafter, a description will be given with respect to a method of reducing a transmission rate for multiplexing by using the out-of-band signaling, in which a voice signal and data are respectively transmitted as separate signaling messages on a signal processing interface (hereinafter, referred to as “Amp”), according to another embodiment of the present invention.

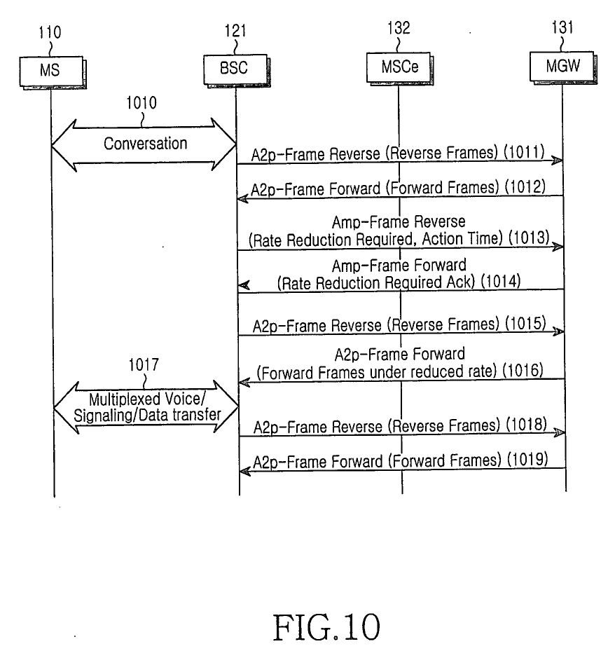

FIG. 10 is a flowchart illustrating operations for reducing a transmission rate for multiplexing transmission of a signaling message and supplementary data in a voice data transmission section according to an embodiment of the present invention.

In step 1010, after a mobile station 110 establishes a session with a base station controller 121, the mobile station 110 performs voice communication with a called party.

After this, in step 1011, the base station controller 121 inserts information bits and a transmission rate of voice data, which are received through a voice data frame from the mobile station 110, into an A2p reverse frame message, and transmits the A2p reverse frame message to the mobile terminal 131. Then, in step 1012, the media gateway 131 inserts information bits and a transmission rate of voice data, which are received through a voice data frame from a media gateway of the called party, into an A2p forward frame message, and transmits the A2p forward frame message to the base station controller 121.

During the performance of a voice call, in step 1013, when a signal or supplementary data to be transmitted from the base station controller 121 to the mobile station 110 are generated, the base station controller 121 records the signal or the supplementary data in an Amp transmission-rate reduction message so as to

The “Action Time” is a field of indicating start system time at which transmission rate reduction is requested. “Signaling Message/Secondary Traffic” is a field of indicating inserted signal message or supplementary data (secondary traffic) when the value of “Signaling message/Secondary Traffic” is set as “1”.

The transmission-rate reduction information includes not only the above-mentioned information elements but also a “Length” information element, and selectively includes “Signaling Message/Secondary Traffic” and “Reserved” information elements. In addition, the transmission-rate reduction information includes a forward-link information element (Forward Link Information+Layer-3 fill).

FIG. 7B is a format illustrating an Amp transmission-rate reduction acknowledgment message of a frame protocol for reducing a transmission rate according to an embodiment of the present invention.

The Amp transmission-rate reduction acknowledgment message includes the same information elements as those of the Amp transmission-rate reduction request message, except for a failure cause information element which is inserted when the Amp transmission-rate reduction request cannot be acknowledged. When an Amp transmission-rate reduction response cannot be acknowledged, each field inserted as the failure cause information element is shown in Table 10. Also, cause values, which are caused between the base station controller and the media gateway, are shown in Table 11.

request transmission-rate reduction according to the DB (Dim and Burst) or the BB (Blank and Burst) scheme at a point of time predetermined for multiplexing, and then transmits the Amp transmission-rate reduction message to the media gateway 131.

In step 1014, when the media gateway 131 acknowledges the transmission-rate reduction request of the base station controller 121, the media gateway 131 transmits an Amp transmission-rate reduction acknowledgment message, which notifies the base station controller 121 that the transmission rate will be reduced according to the DB (Dim and Burst) or the BB (Blank and Burst) scheme at a period of the action time required by the base station controller 121.

In step 1015, the base station controller 121 inserts information and a transmission rate of voice data, which are received through a voice data frame from the mobile station 110, into an A2p reverse frame, and then transmits the A2p reverse frame to the media gateway 131 as before.

In step 1016, the media gateway 131 inserts information and a reduced transmission rate of voice data, which are received through a voice data frame from the media gateway of the called party, into an A2p forward frame message, and transmits the A2p forward frame message to the base station controller.

In step 1017, the base station controller 121 transmits voice data and a signaling message/supplementary data to the mobile station 110 according to the DB (Dim and Burst) or the BB (Blank and Burst) scheme. In step 1018, when there is no signaling message and no supplementary data to be multiplexed and transmitted, the base station controller 121 again normally inserts information bits and a transmission rate of voice data, which is received through a voice data frame from the mobile station 110, into an A2p reverse frame, and transmits the A2p reverse frame to the media gateway 131.

In step 1019, the media gateway 131 inserts information bits and a transmission rate of voice data, which are received through a voice data frame from the media gateway of the called party, into an A2p forward frame, and transmits the A2p forward frame to the base station controller 121.

A description will be given with respect to success and failure procedures of transmission-rate reduction between the base station controller 121 and the media gateway 131 using a DB or a BB scheme in order to reduce the transmission rate between the base station controller 121 and the media gateway 131 by means of the above-mentioned frame protocol.

A transmission-rate reduction procedure using the DB or BB scheme is used for requesting the media gateway to reduce a transmission rate of a trans-coder (or vocoder) therein, or to empty the trans-coder (or vocoder), when there is a layer-3 signaling message or supplementary data to be transmitted from the base station controller to a mobile station in the course of transmitting of voice data of a user. Such a transmission-rate reduction procedure may be achieved by two methods described below. According to the first method, the base station controller notifies the media gateway that there is a layer-3 signaling message or supplementary data to be transmitted from the base station controller to a mobile station. That is, the base station controller first notifies the media gateway when the layer-3 signaling message or supplementary data must be transmitted on the basis of base station system time. Next, when the media gateway transmits a trans-coder (or vocoder) frame in a reduced transmission rate to the base station controller, the base station controller multiplexes the layer-3 signaling message or supplementary data in the relevant trans-coder (or vocoder) frame and transmits the trans-coder frame including multiplexed data to the mobile station.

According to the second method, the base station controller transmits both a layer-3 signaling message or supplementary data and information of when the layer-3 signaling message or supplementary data must be transmitted on the basis of base station system time, to the media gateway. Then, the media gateway multiplexes the signaling message or supplementary data, which are received from the base station controller, with a voice message, and transmits the multiplexed voice message and supplementary data to the base station controller at a full rate, thereby enabling the base station controller to transmit the multiplexed voice message and supplementary data to a relevant mobile station. According to the first method, the transmission-rate reduction procedure using the DB or BB scheme is controlled by the base station controller. According to the second method, the transmission-rate reduction procedure using the DB or BB scheme is requested by the base station controller and is controlled by the media gateway.

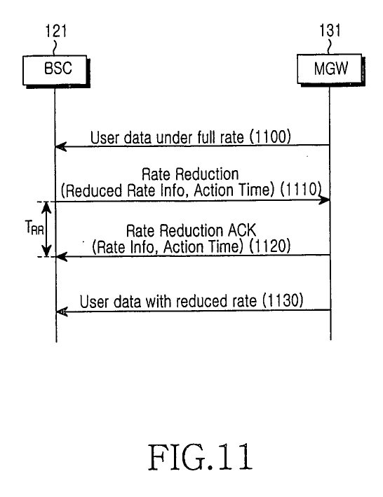

FIG. 11 is a flowchart illustrating operations when a call procedure for reducing a transmission rate is successfully performed according to an embodiment of the present invention.

In step 1100, first, the media gateway 131 transmits voice data at a full rate to the base station controller 121.

In step 1110, when a voice message or supplementary data to be multiplexed and transmitted from base station controller 121 to a mobile station are generated in addition to voice data which are currently being transmitted to the mobile station, the base station controller 121 transmits a transmission-rate reduction request message to the media gateway 131. The transmission-rate reduction request message includes information of a transmission rate, action time, etc., and such information is shown in FIGS. 5A and 7A.

Then, in step 1120, the media gateway 131 prepares to reduce a transmission rate at the action time requested by the base station controller 121. After this, when the media gateway 131 can perform a normal processing operation according to information included in the received transmission-rate reduction request message, the media gateway 131 a transmission-rate reduction acknowledgment message to the base station controller 121. The transmission-rate reduction acknowledgment message includes information of the transmission rate, the action time, etc., and such information is shown in FIGS. 5B and 7B. A period of time (TRR) representing an action time begins after a transmission-rate reduction control frame is transmitted, and ends when the transmission-rate reduction acknowledgment message is received.

After this, in step 1130, the media gateway 131 transmits frames at a reduced transmission rate to the base station controller 121, thereby enabling the base station controller 121 to transmit the voice message or supplementary data terminal together with voice data to the relevant mobile station.

In contrast, when the media gateway cannot perform a normal processing operation for a transmission-rate reduction control frame, the media gateway transmits an NACK message, which includes information of a relevant cause, to the base station controller. As a result, when the base station controller receives an NACK message which includes a cause recorded as “Rate Reduction not supported”, the base station controller checks a transmission rate of voice data frames transmitted from the media gateway during a period of time (TRR) predetermined in a timer which is comprised in the base station controller. As a result, when the transmission rate is not reduced, the base station controller blanks a section of a voice data frame transmitted from the media gateway, and fills the blanked section with a signaling message to transmit frames to the mobile station at a full rate.

As described above, according to the method and the system of the present invention, when base station controller requests transmission-rate reduction to the media gateway, the transmission rate is reduced by a trans-coder (or vocoder) included in the media gateway and is informed to the base station controller, thereby efficiently transmitting a signaling message or supplementary data together with voice data to be transmitted to a mobile station.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

What is claimed is:

1. A method for multiplexing and transmitting a signaling message and/or supplementary data with a voice signal to be transmitted to a mobile station in a mobile communication system which includes a media gateway and a base station controller, the media gateway including a trans-coder for converting an analog voice signal and a coded digital voice signal into each other, the base station controller transmitting/receiving a digital voice signal to/from the media gateway, the method comprising the steps of:
transmitting information of the voice signal and a transmission rate of a voice signal, which are transmitted from the mobile station, from the base station controller to the media gateway;
transmitting information of a voice signal and a transmission rate of the voice signal, which are transmitted from a called party, from the media gateway to the base station controller; and
checking whether or not there is a signaling message and/or supplementary data to be transmitted to the mobile station by the base station controller while the base station controller is transmitting/receiving the voice signal, and multiplexing and transmitting the signaling message and/or the supplementary data with the voice signal to the mobile station when there is the signaling message and/or the supplementary data to be transmitted.

2. The method as claimed in claim 1, further comprising a step of inserting the signaling message and/or the supplementary data instead of the voice signal to be transmitted into a transmission section for the voice signal and transmitting the signaling message and/or the supplementary data to the mobile station, when the transmission rate of the voice signal transmitted from the media gateway to the base station controller is not reduced during a predetermined period of time.

3. The method as claimed in claim 2, wherein the signaling message and/or the supplementary data transmitted instead of the voice signal to the mobile station are transmitted at a full rate.

4. The method as claimed in claim 1, wherein, the step of multiplexing and transmitting the signaling message and/or the supplementary data with the voice signal comprises the steps of:
requesting that the media gateway reduces a transmission rate during a predetermined period of time; and
receiving a response to transmission-rate reduction from the media gateway and transmitting the voice signal and the signaling message and/or the supplementary data to the mobile station by multiplexing the signaling message and/or the supplementary data with the voice signal according to a reduced transmission rate.

5. The method as claimed in claim 3, wherein, in the step of requesting that the media gateway reduces a transmission rate of the voice signal, a transmission-rate reduction request for a predetermined period of time is recorded in a reverse frame message, and the reverse frame message is transmitted together with a transmission frame of a predetermined frame protocol.

6. The method as claimed in claim 5, wherein, the reverse frame message is transmitted through an interface for transmitting data frames of the voice signal, and includes a reverse layer-3 data information which includes an information element for a reduction request and/or an information element for time for transmission-rate reduction time.

7. The method as claimed in claim 3, wherein, a transmission-rate reduction request message is transmitted through a second interface which is established separately from a first interface through which data frames of the voice signal are transmitted, and includes information for transmission-rate reduction and/or an information element for transmission-rate reduction time, and/or information for an identification number of the mobile station.

8. The method as claimed in claim 7, wherein, the transmission-rate reduction request message is transmitted through the second interface which is established separately from the first interface through which data frames of the voice signal are transmitted, and includes information of transmission-rate reduction and information of the identification number of the mobile station.

9. A method for multiplexing and transmitting a signaling message and/or supplementary data with a voice signal to a mobile station by a base station controller in a mobile communication system which includes a media gateway and the base station controller, the media gateway including a trans-coder for converting an analog voice signal and a coded digital voice signal into each other, the base station controller transmitting/receiving a digital voice signal to/from the media gateway, the method comprising the steps of:
judging whether or not there is the signaling message and/or the supplementary data besides of the voice signal;
requesting that the media gateway reduces a transmission rate of the voice signal during a predetermined period of time when there is the signaling message and/or the supplementary data; and
receiving a response to transmission-rate reduction of the voice signal from the media gateway and transmitting the voice signal and the signaling message and/or the supplementary data to the mobile station by multiplexing the signaling message and/or the supplementary data with the voice signal according to a reduced transmission rate.

10. The method as claimed in claim 9, wherein, in the step of requesting that the media gateway reduces a transmission rate of the voice signal, a transmission-rate reduction request for a predetermined period of time is recorded in a reverse frame message, and the reverse frame message is transmitted together with a transmission frame of a predetermined frame protocol.

11. The method as claimed in claim 10, wherein, the reverse frame message is transmitted through an interface for transmitting data frames of the voice signal, and includes a reverse layer-3 data information which includes an information element for a reduction request and/or an information element for transmission-rate reduction time.

12. The method as claimed in claim 9, wherein, in the step of requesting that the media gateway reduces a transmission rate of the voice signal, a transmission-rate reduction request for a predetermined period of time is recorded in a transmission-rate reduction request message, and the transmission-rate reduction request message is transmitted separately from a transmission frame of a frame protocol.

13. The method as claimed in claim 12, wherein, the transmission-rate reduction request message is transmitted through a second interface which is established separately from a first interface through which data frames of the voice signal are transmitted, and includes information of transmission-rate reduction and/or an information element for transmission-rate reduction time, and/or information of an identification number of the mobile station.

14. A method for reducing a transmission rate of a voice signal so that a media gateway can multiplex and transmit the voice signal and a signaling message and/or supplementary data to a mobile station in a mobile communication system which includes the media gateway and a base station controller, the media gateway including a trans-coder for converting an analog voice signal and a coded digital voice signal into each other, the base station controller transmitting/receiving a digital voice signal to/from the media gateway, the method comprising the steps of:
reducing a transmission rate of the voice data when the base station controller requests transmission-rate reduction of the voice signal; and
transmitting a response to the voice signal transmission-rate reduction request to the base station controller within a predetermined period of time.

15. The method as claimed in claim 14, wherein, a resultant of the reduced transmission rate is record in a forward frame message, and the forward frame message is transmitted together with a transmission frame of a frame protocol.

16. The method as claimed in claim 15, wherein, the forward frame message is transmitted through an interface for transmitting data frames of the voice signal, and includes a forward layer-3 data information which includes a resultant information element for transmission-rate reduction and/or an information element for the predetermined transmission-rate reduction time period.

17. The method as claimed in claim 14, wherein, a resultant of the reduced transmission rate is record in a transmission-rate reduction response message, and the transmission-rate reduction response message is transmitted separately from a transmission frame of a frame protocol.

18. The method as claimed in claim 17, wherein, the transmission-rate reduction response message is transmitted through a second interface which is established separately from a first interface through which data frames of the voice signal are transmitted, and includes resultant information of transmission-rate reduction and/or an information element for transmission-rate reduction time and/or information of an identification number of the mobile station, and/or information of failure cause.

19. A system for multiplexing and transmitting a signaling message and/or supplementary data with a voice signal to be transmitted to a mobile station in a mobile communication system which includes a media gateway and a base station controller, the media gateway including a trans-coder for converting an analog voice signal and a coded digital voice signal into each other, the base station controller transmitting/receiving a digital voice signal to/from the media gateway, the system comprising:
the media gateway for transmitting information of a voice signal and a transmission rate of the voice signal, which are transmitted from a called party, to the base station controller; and
the base station controller for transmitting information of a voice signal and a transmission rate of the voice signal, which are transmitted from the mobile station, to the media gateway, checking whether or not there is a signaling message and/or supplementary data to be transmitted to the mobile station while the base station controller is transmitting/receiving the voice signal, and multiplexing and transmitting the signaling message and/or the supplementary data with the voice signal to the mobile station when there is the signaling message and/or the supplementary data to be transmitted.

20. The system as claimed in claim 19, wherein the base station controller inserts the signaling message and/or the supplementary data instead of the voice signal to be transmitted into a transmission section for the voice signal and transmits the signaling message and/or the supplementary data to the mobile station, when the transmission rate of the voice signal transmitted from the media gateway to the base station controller is not reduced during a predetermined period of time.

21. The system as claimed in claim 20, wherein the signaling message and/or the supplementary data transmitted instead of the voice signal to the mobile station are transmitted at a full rate.

22. The system as claimed in claim 19, wherein, the base station controller requests that the media gateway reduces a transmission rate during a predetermined period of time, receives a response to transmission-rate reduction from the media gateway, and transmits the voice signal and the signaling message and/or the supplementary data to the mobile station by multiplexing the signaling message and/or the supplementary data with the voice signal according to a reduced transmission rate.

23. The system as claimed in claim 19, wherein, in order to request that the media gateway reduces a transmission rate of the voice signal the base station controller records a transmission-rate reduction request for a predetermined period of time in a reverse frame message, and transmits the reverse frame message with a transmission frame of a predetermined frame protocol.

24. The system as claimed in claim 23, wherein, the reverse frame message is transmitted through an interface for transmitting data frames of the voice signal, and includes a reverse layer-3 data information which includes an information element for a reduction request and/or an information element for transmission-rate reduction time.

25. The system as claimed in claim 19, wherein, in order to request that the media gateway reduces a transmission rate of the voice signal, the base station controller records a transmission-rate reduction request for a predetermined period of time in a transmission-rate reduction request message, and transmits the transmission-rate reduction request message separately from a transmission frame of a frame protocol.

26. The system as claimed in claim 25, wherein, the transmission-rate reduction request message is transmitted through a second interface which is established separately from a first interface through which data frames of the voice signal are transmitted, and includes information of transmission-rate reduction and/or an information element for transmission-rate reduction time, and/or information of an identification number of the mobile station.
